(19) United States
(12) Patent Application Publication
(10) Pub. No.: US 2003/0109986 A1
(43) Pub. Date: Jun. 12, 2003

(54) Road navigation method and system

(76) Inventor: Eric Tseng, Taipei (TW)

Correspondence Address: J.C. Patents, Inc., Suite 250, 4 Venture, Irvine, CA, 92618, US

(21) Appl. No.: 10/015,416

(22) Filed: Dec. 12, 2001

(51) Int. Cl. G01C 21/34

(52) U.S. Cl. 701/211; 701/209; 340/988

(57) ABSTRACT

A road navigation method is for a user with a moving terminal, driving on the road guided by a control terminal. The method comprises the user communicating with the control terminal, and choosing start point and end point of a path. Control terminal calculates an optimized path and generates a navigation voice message content according to the start point, the end point and the database. Control terminal generates at least a node and a corresponding broadcast second number. The message content, the node, and the broadcast second number are subsequently transmitted to the moving terminal via a wireless message transmission system. The moving terminal stores the navigation voice message content, the node, and the broadcast second number, and detects and obtains a current position of the moving terminal by using the positioning system. When the position of the moving terminal approaches to a node within a proper distance, a portion of the message content is broadcast.

### BACKGROUND OF THE INVENTION

1. Field of Invention

The present invention generally relates to a road navigation method and system. More particularly, it relates to real-time road navigation by using the voice, without the assistance of image information of the road and maps.

2. Description of Related Art

Accompanying the development of cities, road connections are getting more complicated and the ranges covered are also becoming larger. People who live in the city need to move from one place to another. To a person in an area with which they are familiar and which has a simple road structure, it is not complicated to find a path to arrive at the destination easily. However, it is bothersome to get to the destination when a person is in an area with which they are unfamiliar and which has a complicated road structure. Even though they know the path, city traffic jams can happen anytime in the path. Therefore, how to get through by the best path to get to the chosen destination is not easy to evaluate.

Thanks to the advancements in communication technology and continuous breakthroughs in video technology, the possibility of a wireless road navigation method has begun to be realized. In the market today, there are service vendors who offer a navigation system, which provides road information to the users and leads the users to the desired destinations.

Generally, the form of the automobile navigation system is a closed system, which uses a positioning sensor unit equipped in the automobile, including the global positioning system (GPS) and electronic map for path planning and navigation. The disadvantage is that the map information is not in real time and so the path planning is not able to refer the real time traffic status. If there is a need to receive the road status in real time, hardware equipment, such as the radio data system (RDS), needs to be added. Furthermore, the information transmitter is not popular which causes high equipment cost.

Currently, the communication vendors of the global system for mobile telecommunication (GSM), have started to provide a local base service. As shown in FIG. 1, the method detects the current position of the user by using global system for mobile telecommunication (GSM) base stations for a triangular positioning. In FIG. 1, in a physical street structure 100, the automobile 104 is driving on a road 102. The global system for mobile telecommunication (GSM) base stations 106, 108 and 110 operate a triangular positioning. As shown in FIG. 2, the information from a target object 120 that is around the user is further provided to the user. The information is in the manner of a voice to inform the user, or by displaying text or a map on the user's personal digital assistant (PDA) via the wireless application protocol (WAP). The positioning error of the global system for mobile telecommunication (GSM) is several hundred meters, and thus it cannot be used for navigation.

### SUMMARY OF THE INVENTION

In order to solve the problem mentioned above, the present invention provides a road navigation method. The method integrates the characteristics of the global positioning system (GPS) and the global system for mobile telecommunication (GSM), provides integrated real-time traffic status in the manner of voice and digital data, and also navigates the users in real-time by using the node target object.

The present invention provides a road navigation method. The method is suitable for a user with a moving terminal, driving on the road guided by a control terminal. The road navigation method comprises a user, communicating with the control terminal, who chooses a start point and an end point of a path. The control terminal calculates and determines an optimized path according to the start point, the end point and the database information, and also generates a navigation voice message content. The control terminal further generates at least a node and a corresponding broadcast second number according to the navigation voice message content. The navigation voice message content, the node, and the broadcast second number are transmitted to the moving terminal via a wireless message transmission system. The moving terminal subsequently stores the navigation voice message content, the node, and the broadcast second number. A current position of the moving terminal is obtained by using the positioning system. When the position of the moving terminal approaches to the node, the navigation voice message content is extracted in proper time and the portion of the navigation voice message content of this node is broadcasted.

The present invention further provides a road navigation system. The system is suitable for a user who is navigated to drive on the road by using a positioning system and a wireless message transmission system. The road navigation system comprises a moving terminal and a control terminal, wherein the moving terminal is equipped in the user side, and the control terminal is used to calculate an optimized path. The control terminal provides information to the moving terminal, the information includes a navigation voice message that corresponds to the optimized path, and also sets up at least a node and a corresponding broadcast second number.

The moving terminal comprises a microprocessor unit, a positioning sensor element, a wireless message interface unit, a storage device, and a broadcast device. The microprocessor unit processes the input and output data and controls a plurality of elements that are connected to the microprocessor unit. The positioning sensor element is connected to the microprocessor unit, cooperates with the positioning system, detects and obtains a current position of the moving terminal. The wireless message interface unit is connected to the microprocessor unit, and interchanges messages with the control terminal via the wireless message transmission system. The storage device is connected to the microprocessor unit, and stores the navigation voice message content, the node, and the corresponding broadcast second number that are provided by the control terminal. The broadcast device is controlled by the microprocessor unit and used to broadcast the navigation voice message content.

The control terminal mentioned above, for example, further comprises a control center unit, a control program unit, a database, and a wireless data transmission getway unit. The control center unit communicates with the moving terminal and obtains a start point and an end point. The control program unit is connected to the control center unit, calculates and determines the optimized path according to the start point and the end point. The database is connected to the control program unit, and includes updated road traffic status information and road map information. The wireless data transmission getway unit is connected to the control program unit, and interchanges messages with the moving terminal via the wireless message transmission system.

The control terminal mentioned above further comprises a message getway unit, a control program unit and a database. The message getway unit interchanges messages with the moving terminal via the wireless message transmission system, and obtains a start point and an end point. The control program unit is connected to the message getway unit, and calculates and determines the optimized path according to the start point and the end point. The database is connected to the control program unit, and includes updated road traffic status information and road map information.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a street automobile driving status, and the positioning mechanism of the global system for mobile telecommunication (GSM);

FIG. 2 schematically shows an automobile driving on the road, and the node target object;

FIGS. 3A-3B schematically shows the technique of the road navigation system, which integrates the global system for mobile telecommunication (GSM) and the global positioning system (GPS) according to the present invention;

FIGS. 4A-4B schematically shows the technique of the road navigation system, which integrates the general packet radio service (GPRS) and the global positioning system according to the present invention;

FIG. 5 shows the method of road navigation referring to FIGS. 3A-3B according to the present invention;

FIG. 6 shows the method of road navigation referring to FIGS. 4A-4B according to the present invention, and

FIG. 7 shows the structure of the navigation voice message content according to the present invention.

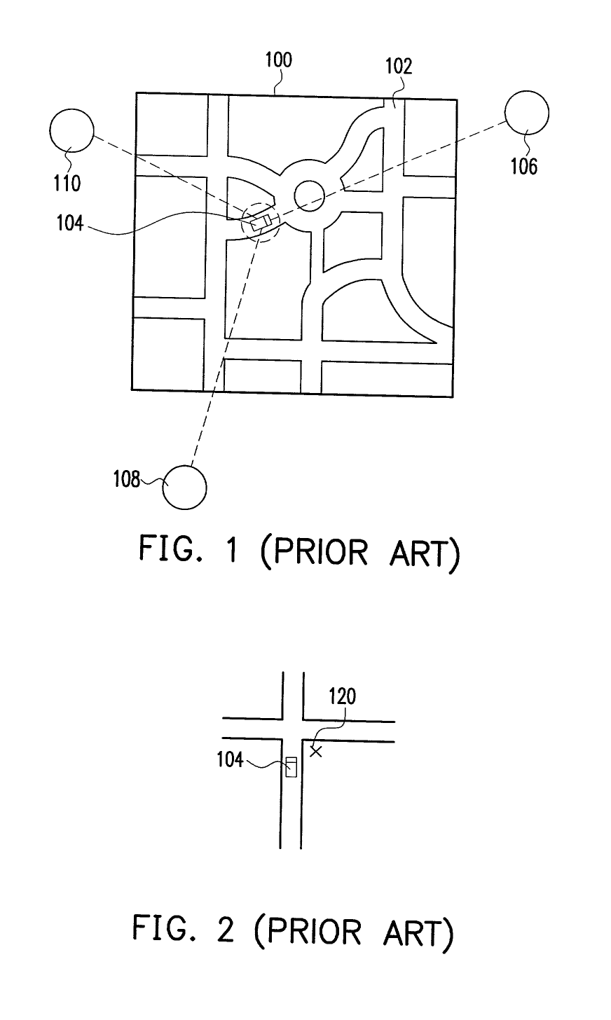

### DESCRIPTION OF THE PREFERRED EMBODIMENTS

One of the major characteristics of the present invention is providing integrated real-time traffic status in the manner of integrated voice and digital data, by integrating the techniques of the global positioning system and the global system for mobile telecommunication (GSM), and navigating the users in real time by using the target object of the node.

A few embodiments are exemplified below for explanation. The road navigation method according to the present invention is characterized by, for example, transmitting the positioning data of the GPS to a control center by using the show message system (SMS) (or the general packet radio service, GPRS) of the GSM. The control center integrates with the map database and the real-time traffic status via the Internet. Users choose or utilize the GPRS/WAP to transmit the end point to the control center by calling the control center via the GSM. Thus, the optimized path can be calculated by using the map database and the real-time traffic status information. The road node information subsequently is transmitted to the user side through the SMS (or GPRS) of the GSM. Users obtain the current position by using the sensor device of the GPS that is equipped in the automobile and by the characteristic of GPS that it is re-positioned once per second. The current position is compared with the node. Once a certain node is approached, the pre-recorded message content or the corresponding paragraph of the digital voice compressed file is broadcast in the manner of a voice to accomplish the navigation function. The hardware cost is reduced significantly compared to the conventional hardware cost. In addition, the annoyance of the requirement to update the map database no longer exists.

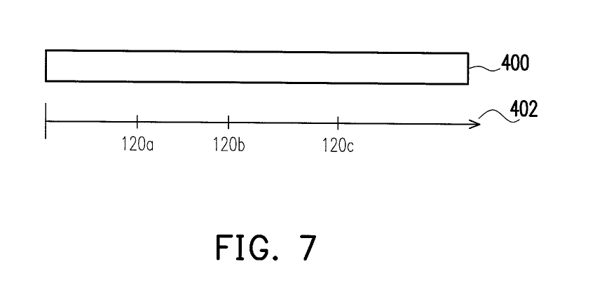

In order to have more efficient navigation and make the structure easier, the navigation content according to the present invention is designed as the mechanism shown in FIG. 7. The navigation content is a voice broadcast message content 400. The voice broadcast message content 400 is emplaced on the broadcast time axis 402 according to the broadcast speed. As shown in FIG. 2, there are a few key nodes, such as at turnings in the road. The control terminal of the present invention sets up a few nodes, like node 120a, 120b, and 120c, on the broadcast time axis 402, according to the map database and the real-time traffic status. The corresponding voice broadcast message content 400 is then guided by the recognizable structure of the current position, for example, “turn right at the approaching intersection,” “take the right side as the approaching road splits into two,” . . . etc. A broadcast second number corresponds to the portion of the paragraph content that is broadcast. Therefore, when the user approaches a certain node, the related road information of the approaching node is broadcast, and the broadcast information corresponds to the broadcast second number. Once the navigation is started, the whole or only a paragraph of the navigation voice message content 400 may be broadcast. This is just a variant of the design, and does not depart from the mechanism of the navigation voice message content 400 according to the present invention.

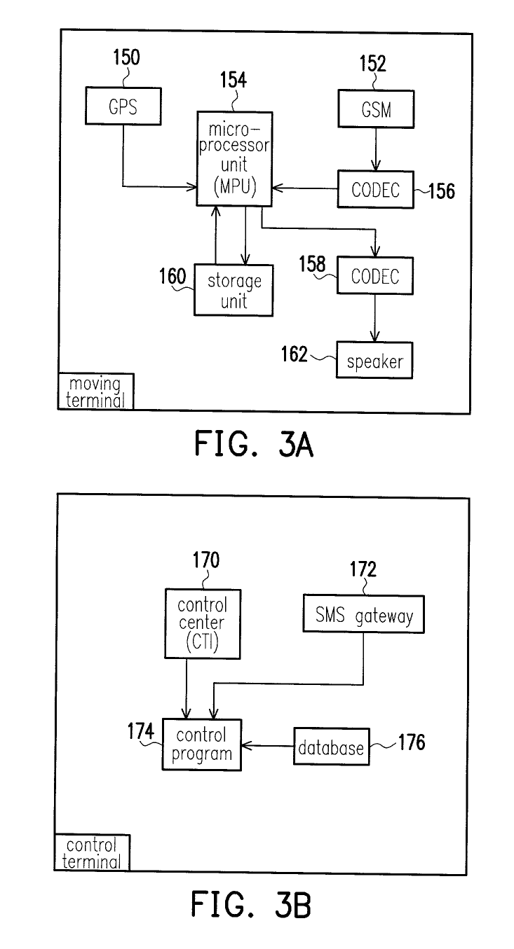

FIGS. 3A-3B schematically shows the technique of the road navigation system, which integrates the global system for mobile telecommunication (GSM) and the global positioning system (GPS) according to the present invention. The road navigation system according to the present invention comprises a moving terminal that is equipped in the user side, and a control terminal that provides the navigation service. The equipment of the moving terminal is shown in FIG. 3A, while the equipment of the control terminal is shown in FIG. 3B.

FIG. 3A comprises a microprocessor unit 154, a positioning sensor unit GPS 150, a wireless message transmission interface 152, an encoder/decoder 156, and a storage unit 160. The microprocessor unit 154 processes and controls all the data. The positioning sensor unit GPS 150 is connected to the microprocessor unit 154, and cooperates with the GPS positioning system, detects and obtains a current position of the moving terminal. The positioning information is then input into the microprocessor unit 154 to compare with the node information later. The wireless message transmission interface 152, for example, is the global system for mobile telecommunication (GSM) interface unit. The encoder/decoder 156 is connected in between the wireless message transmission interface 152 and the microprocessor unit 154, and processes the transformation of the voice. The storage unit 160 is connected to the microprocessor unit 154, the microprocessor unit 154 accesses the data that is stored in the storage unit 160. The position information and the navigation voice message content 400 that are input by the positioning sensor unit GPS 150 and the global system for mobile telecommunication (GSM) interface unit may be stored in the storage unit 160. The microprocessor 154 then compares the current position information with the node information, and when an adequate position is approached, the microprocessor unit 154 extracts and broadcasts the corresponding paragraph of the navigation voice message content 400. A speaker unit executes the broadcast. The speaker unit, for example, comprises an encoder/decoder 158 and a speaker 162, and receives the output from the microprocessor unit 154.

In addition, FIG. 3B shows the equipment of the control terminal. The equipment of the control terminal comprises a control center 170, a SMS getway unit 172, a control program unit 174, and a database 176. The control center 170, the SMS getway unit 172, and the database 176 are all connected to the control program unit 174, to process the data. The control center 170 exchanges the information with the user of the moving terminal, once the start point and the end point of the path are obtained. The start point and the end point are then input to the control program unit 174, to process the calculation of the optimized path. The start point of the path also may be obtained via the system automatically. When calculating the optimized path, the database 176 provides the updated traffic status and road map information, for the estimation of the optimized path.

When the optimized path is obtained, the control program unit 174 generates a navigation voice information 400, the corresponding nodes such as 120a, 120b, 120c, and the broadcast second number. This information is transmitted to the moving terminal and stores in the storage unit 160 via the SMS getway unit 172.

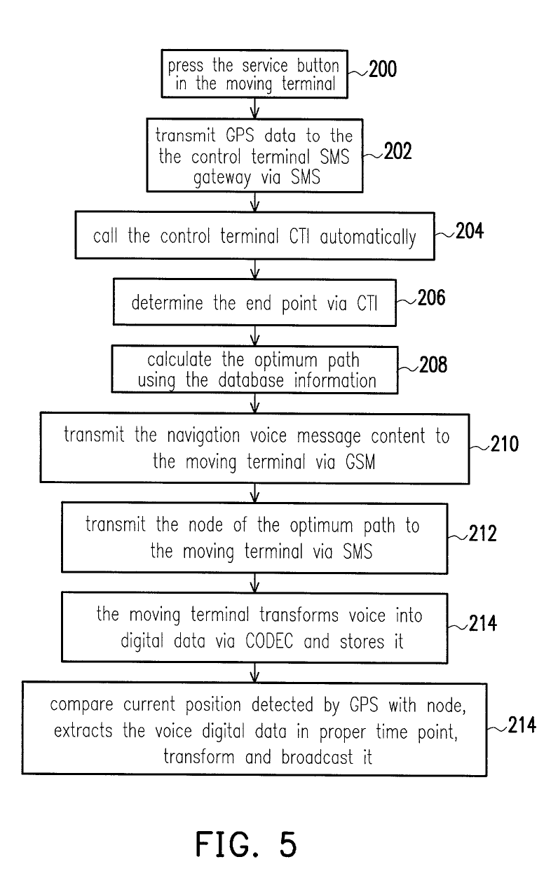

The descriptions above are all related to the equipment of the road navigation system. The method of the road navigation, for example, is shown in FIG. 5. In step 200, the user presses the service button in the moving terminal. In step 202, the moving terminal transmits the information of the global positioning system to the SMS getway unit 172 of the control terminal by using the SMS system. In step 204, the moving terminal calls the control center 154 of the control terminal automatically. In step 206, the control center 154 exchanges information with the user to determine the end point. In step 208, the control terminal calculates the optimized path by using the information of the database 176, and generates a navigation voice message content. In step 210, the navigation voice message content is transmitted to the moving terminal via the GSM voice. In step 212, the key nodes and the corresponding broadcast second number are analyzed and obtained, and are transmitted to the moving terminal. In step 214, the moving terminal stores the received data into the storage unit 160 by using the encoder/decoder. In step 216, the moving terminal compares the position information that is detected by the GPS with the key node information. Once a certain node position is approached, a portion of the navigation voice message content 400 that corresponds to the node is extracted in proper time point, and is broadcast after the transformation.

As an example to simulate the physical situation, the broadcast length of the navigation voice message content 400 is 3.5 seconds. The key nodes are located at 1.2 second and 2.6 second time point. At first, for example, the “Navigation is commenced, please go straight along Li-Shin Road” may be broadcast. When approaching somewhere thereabout having a pre-determined distance to the first node, a portion of the navigation voice message content 400, from 1.2 second to 2.6 second time point, for example, “Please turn right onto Chun-Shan Road at the approaching intersection” is broadcast. When approaching the second node, a portion of the navigation voice message content 400, from 2.6 second to 3.5 second time point is broadcast. The voice messages mentioned above may be broadcast repeatedly as long as it is necessary.

The navigation system and method mentioned above determines the end point of the path by using the GSM and SMS. The communication between the moving terminal and the control terminal can be replaced by other methods. For example, the general package radio service (GPRS) can be used for this communication. The GPRS provides faster message transmission speed and allows more data to be transmitted. Thus, the steps for a user to determine the end point are much easier.

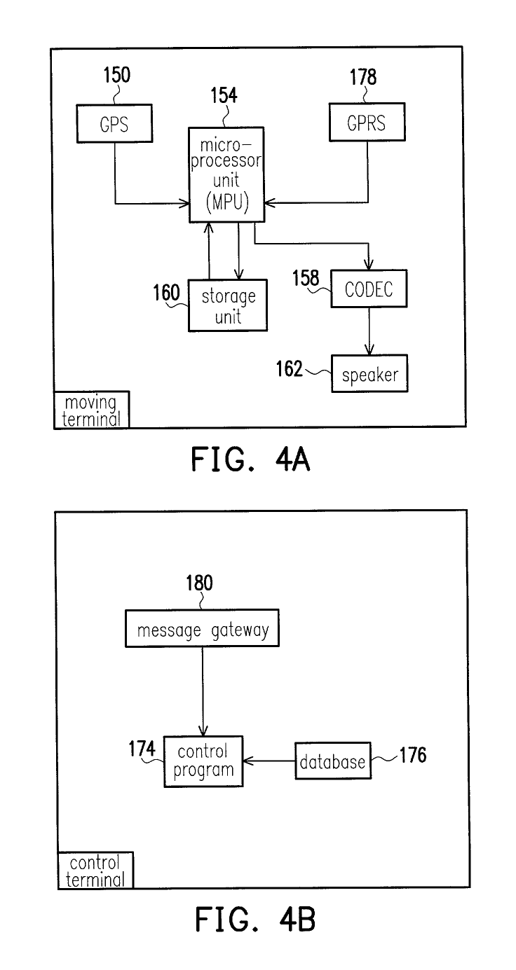

FIGS. 4A-4B schematically shows the technique of the road navigation system, which integrates the general packet radio service (GPRS) and the global positioning (GPS) according to the present invention. FIG. 4A schematically shows the equipment of the moving terminal, while FIG. 4B schematically shows the equipment of the control terminal. The equipment of the moving terminal is approximately the same as the equipment of the moving terminal shown in FIG. 3A. The difference between them is that the wireless communication system of FIG. 4A uses the general packet radio service (GPRS). The GPRS service, which belongs to the new generation method of the GSM, allows higher data transmission speed.

The control terminal comprises a message getway unit 180, a control program unit 174, and a database 176. In the present embodiment, the control terminal is able to choose the start point and the end point of the path automatically without the operation of the control center.

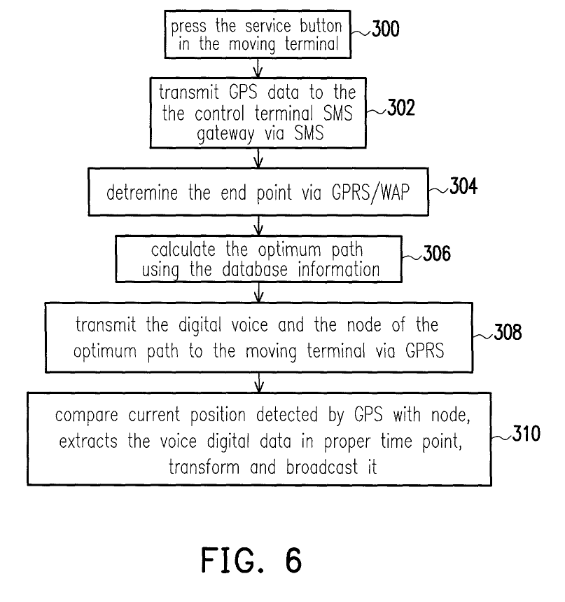

FIG. 6 shows the method of the road navigation referring to FIGS. 4A-4B according to the present invention. In step 200, the user presses the service button in the moving terminal. In step 202, the moving terminal transmits the information of the global positioning system to the getway unit 180 of the control terminal by using the GPRS system. In step 204, the end point of the path is chosen directly via the manner of the WAP of the GPRS unit 178 in the moving terminal. In step 208, the control terminal calculates the optimized path by using the information of the database 176, and generates a navigation voice message content. The key nodes and the corresponding broadcast second number are also analyzed and obtained. In step 210, the navigation voice message content, the key nodes, and the corresponding broadcast second number are transmitted to the moving terminal via the GPRS system. In step 212, the moving terminal compares the position information detected by the GPS with the key node. Once a certain node position is approached, a portion of the navigation voice message content 400 that corresponds to the node is extracted in proper time point, and is broadcast after the transformation.

As described by the embodiment above, the characteristic of the present invention comprises integrating the techniques of the global positioning system and the global system for mobile telecommunication (GSM) or the general package radio service (GPRS), providing integrated real-time traffic status, in the manner of integrated voice and digital data, and navigating the users in real time by using the node target object. The cost of the equipment of the navigation system according to the present invention is reduced significantly, thus making it suitable for the public users.

Although the invention has been described with reference to a particular embodiment thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1 A road navigation method, suitable for a user with a moving terminal, driving on the road guided by a control terminal, the road navigation method comprising:
the user communicating with the control terminal, choosing a start point and an end point of a path;
the control terminal calculating and determining an optimized path according to a database and the path;
the control terminal generating a navigation voice message content corresponding to the path;
the control terminal generating at least a node and a corresponding broadcast second number according to the path;
transmitting the navigation voice message content, the node, and the broadcast second number to the moving terminal via a wireless message transmission system;
the moving terminal storing the navigation voice message content, the node, and the broadcast second number; and
detecting and obtaining a current position of the moving terminal by using a positioning system,
wherein, when the current position of the moving terminal approaches to one of the nodes within a pre-determined proper distance, a portion of the navigation voice message content corresponding to the approaching node and the broadcast second number is extracted and broadcast.

2. The road navigation method of claim 1, wherein the database of the control terminal comprises an updated traffic status database and a map database.

3. The road navigation method of claim 1, wherein the positioning system comprises a global positioning system.

4. The road navigation method of claim 1, wherein the wireless message transmission system comprises a global system for mobile telecommunication GSM system.

5. The road navigation method of claim 1, wherein the wireless message transmission system comprises a general packet radio service GPRS system.

6. The road navigation method of claim 1, wherein the method further comprises: at first, broadcasting one time of the whole content of the navigation voice message content.

7. The road navigation method of claim 1, wherein the positioning system detects and obtains the current position of the moving terminal continuously once per a fixed time period.

8. A road navigation system, using a pointing system and a wireless message transmission system, the system being suitable for a user who is navigated to drive on the road, the road navigation system comprising:
a moving terminal, which is equipped in the user side, and
a control terminal, which calculates an optimized path, and provides information to the moving terminal, the information including a navigation voice message content corresponding to the optimized path, and also sets up at least a node and a corresponding broadcast second number, wherein
the moving terminal comprises:
a microprocessor unit, which processes the input and output data, and controls a plurality of elements that are connected to the microprocessor unit;
a positioning sensor unit, which is connected to the microprocessor unit, cooperates with the positioning system, detects and obtains a current position of the moving terminal,
a wireless voice interface unit, which is connected to the microprocessor unit, interchanges information with the control terminal via the wireless message transmission system;
a storage unit, which is connected to the microprocessor unit, stores the navigation voice message content, the node, and the corresponding broadcast second number that are provided by the control terminal; and
a broadcast device, which is controlled by the microprocessor unit, and broadcasts the navigation voice message content.

9. The road navigation system of claim 8, wherein the control terminal comprises:
a control center unit, that communicates with the moving terminal, and obtains a start point and an end point;
a control program unit, which is connected to the control center unit, and calculates the optimized path according to the start point and the end point;
a database, which is connected to the control program unit, the database comprises updated traffic status information and road map information; and
a wireless data transmission getway unit, which is connected to the control program unit, and interchanges information with the moving terminal via the wireless message transmission system.

10. The road navigation system of claim 9, wherein the wireless data transmission getway unit comprises a show message system getway (SMS Getway).

11. The road navigation system of claim 8, wherein the control terminal comprises:
a message getway unit, which interchanges information with the moving terminal via the wireless message transmission system, and obtains a start point and an end point;
a control program unit, which is connected to the message getway unit, which calculates the optimized path according to the start point and the end point; and
a database, which is connected to the control program unit, the database comprises updated traffic status information and road map information.

12. The road navigation system of claim 11, wherein the message getway unit comprises a general packet radio service getway (GPRS Getway).

13 The road navigation system of claim 8, wherein the wireless voice interface unit of the moving terminal comprises an interface of the global system for mobile telecommunication GSM system.

14. The road navigation system of claim 8, wherein the wireless voice interface unit of the moving terminal comprises an interface of the general packet radio service GPRS system.

15. The road navigation system of claim 8, wherein the wireless voice interface unit of the moving terminal comprises an encoder/decoder, which is connected to the microprocessor unit for processing the voice.
